(19) United States
(12) Patent Application Publication
(10) Pub. No.: US 2015/0296373 A1
(43) Pub. Date: Oct. 15, 2015

(54) Device, System and Process for Providing and/or Activating Network Services on a Wireless Device Dispensed from a Vending Machine

(71) Applicant: TracFone Wireless, Inc., Miami, FL (US)

(72) Inventors: Janet Morejon, Miami, FL (US); Shoaib Khan, Miami, FL (US); Mario Echica, Miami, FL (US); Jose A. Hernandez, Miami, FL (US)

(21) Appl. No.: 14/685,015

(22) Filed: Apr. 13, 2015

Related U.S. Application Data
(60) Provisional application No. 61/978,407, filed on Apr. 11, 2014.

(51) Int. Cl. H04W 8/26; G06Q 20/18

(52) U.S. Cl. CPC H04W 8/265; G06Q 20/18

(57) ABSTRACT

A method and system for the purchase of a wireless device and the activation of services on a wireless device are provided. The method and system include a vending machine that can improve a user's experience and ease of activation/provisioning of services for the wireless device by providing a new local provisioning channel for service activations at the point-of-sale of one or both the wireless device and a network service. The vending machine is configured to transmit an activation message along with other device-related information over the provisioning channel. The services to be activated may include at least one of the following: out of the box activation, device upgrades, device reactivations, wireless number changes, wireless number porting, and the addition or purchasing of services including airtime, enrollments or content.

### CROSS REFERENCE TO PRIOR APPLICATIONS

This application claims the benefit from U.S. Provisional Application No. 61/978,407 filed on Apr. 11, 2014, which is hereby incorporated by reference for all purposes as if fully set forth herein.

### BACKGROUND OF THE DISCLOSURE

1. Field of the Disclosure

The invention relates to a device, system and methods for activating wireless services on wireless devices. More particularly, the invention relates to a device, system, and methods for activating wireless services on wireless devices dispensed from a vending machine.

2. Related Art

Generally, most wireless devices are sold to users at a retail establishment or over the Internet and delivered by mail. If the wireless device is sold in a retail establishment, such establishments are not always convenient to a user. For example, such a retail establishment is less likely to be in a transient location such an airport terminal, train station, or the like. Moreover, such retail establishments have limited hours of operation due to operational costs. On the other hand, obtaining wireless devices over the Internet requires an Internet connection and Internet access. Both approaches take time in order to obtain the wireless device and furthermore obtain provisioned service for the wireless device. For example, a user must locate and travel to a retail establishment in order to obtain wireless service in that manner. On the other hand, obtaining wireless services over the Internet requires the user to wait until the wireless device is delivered by mail or the like. Convenience and timeliness would be a key factor for a user that is traveling and has lost their wireless device or needs a wireless device for use in a country where their phone does not operate or does not operate in a cost-effective manner. Thus, a user needs to obtain a wireless device easily, at any given hour, and in an expedited manner.

Accordingly, a convenient and time efficient approach is needed for a user to obtain a wireless device that may be quickly activated for use.

### SUMMARY OF THE DISCLOSURE

The foregoing needs are met, to a great extent, by the invention, providing a method and a system for activating services and subscriptions on a wireless device dispensed from a vending machine. In particular, the invention is intended to solve the challenges by using a provisioning channel used to request and activate the services of an unprovisioned wireless device. According to some aspects of the disclosure, the services requested to be activated may include at least one of initial provisioning or activation, device upgrades, device reactivations, wireless number changes, the addition or purchasing of services including airtime, enrollments or content, and wireless number porting for wireless devices that have already been activated.

According to aspects of the disclosure, a method for activating services on a wireless device is disclosed. The method including providing a vending machine configured to receive at least one user input selection to be used for activating services on a wireless device, the providing further including providing the vending machine configured to automatically retrieve device-related information, where the device-related information includes at least a serial number for the wireless device, the providing further including providing the vending machine configured to generate an activation message including one or both of the at least one user input selection and the device-related information, and the providing further including providing the vending machine configured to transmit, using a provisioning channel, the activation message to a subscriber provisioning system.

According to some aspects, the method of providing wireless services on a wireless device can include receiving a user input selection through a user interface of a vending machine providing wireless services and wireless devices, where the user input selection relates to at least one of a wireless service and a wireless device selection, retrieving, using the vending machine, device-related information according to the user input selection, where the device-related information includes at least a serial number for the wireless device, generating, using the vending machine, an activation message including the device-related information, and transmitting, using a provisioning channel, the activation message to a subscriber provisioning system configured to activate services on wireless devices.

In additional aspects of the disclosure, a system is configured to provide wireless services via a vending machine. The vending machine including a keypad configured to receive at least one user input selection used for activating one or more services on a wireless device, a processor in communication with the keypad and a transceiver, where the processor is configured to automatically retrieve device-related information including at least one of a serial number for the wireless device and a serial number for a subscriber identity module (SIM) card installed in the wireless device upon receiving the at least one user input selection, generate an activation message including the automatically retrieved device-related information, and transmit, using the transceiver and a provisioning channel, the activation message to a subscriber provisioning system configured to activate services on the wireless device.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

The above-mentioned features and aspects of the disclosure will become more apparent with reference to the following description taken in conjunction with the accompanying drawings wherein like reference numerals denote like elements and in which:

FIG. 1 illustrates a schematic diagram of a wireless device provisioning system in accordance with aspects of the disclosure.

FIG. 2 is a schematic block diagram of a wireless device in accordance with aspects of the disclosure.

FIG. 3 is an operation flow diagram illustrating a method of generating an activation message for a wireless device from a vending machine in accordance with aspects of the disclosure.

FIG. 4 is an operation flow diagram illustrating a method of forwarding an activation message over a wireless carrier network in accordance with aspects of the disclosure.

FIG. 5 is an operation flow diagram illustrating a method of operating a subscriber provisioning system to activate services on a wireless device in accordance with aspects of the disclosure.

FIG. 6 is an exemplary vending machine configured to activate services on a wireless device in accordance with aspects of the disclosure.

FIG. 7 is a flow diagram illustrating method steps associated with the activation of a wireless device according to aspects of the disclosure.

### DETAILED DESCRIPTION

In this specification and claims it is to be understood that reference to an electronic device is intended to encompass wireless devices such as mobile phones, tablet computers, gaming systems, MP3 players and the like. A “wireless device” is intended to encompass any compatible mobile technology computing device that connects to a wireless communication network, such as mobile phones, mobile equipment, mobile stations, user equipment, cellular phones, smartphones, handsets or the like (e.g., Apple iPhone, iPad, Google Android based devices, BlackBerry based devices, other types of PDAs or smartphones), wireless dangles, or other mobile computing devices. The term “wireless device” may be interchangeably used and referred to herein as “wireless handset,” “handset,” “mobile device,” “device,” “mobile phones,” “mobile equipment,” “mobile station,” “user equipment,” “cellular phone,” “smartphones,” or “phone.”

A point-of-sale as used herein can refer to a location where one or more wireless devices and/or services can be sold and/or activated without requiring sales personnel. A point-of-sale can include, for example, a vending machine, an automated kiosk, and such.

Wireless devices may connect to a “wireless network” or “network” and are intended to encompass any type of wireless network to obtain mobile phone services through the use of a wireless device, using a communication channel as described herein, that may utilize the teachings of the present application to allow a wireless device to connect to a wireless network.

Reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not for other aspects.

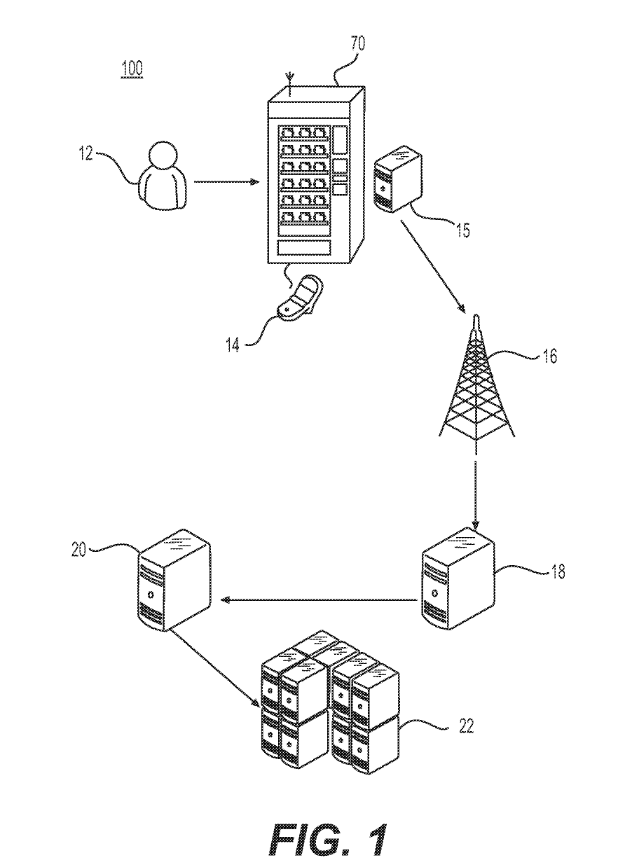

Referring now to FIG. 1, a schematic diagram of a wireless device provisioning system 100 according to aspects of the disclosure is illustrated. In particular, the wireless device provisioning system 100 may be used in conjunction with a vending machine 70 to activate a wireless device and/or network services on a wireless device 14. Unlike conventional activation processes for wireless devices that can require a user 12 to contact a live customer service representative, utilize an interactive voice response system from a landline or another wireless device, or access an Internet website by the user 12 to use a website activation system in order to activate services on a wireless device, the wireless device provisioning system 100 can be used to activate a wireless device 14 and/or activate services without requiring access to an agent, website, or general wireless or landline telephone system. According to aspects of the disclosure, the activated services may include, for example, the initial activation of the wireless device 14 by a user 12 and/or a seller. This initial activation of the wireless device 14 may be described herein as “out of the box” activation.

In some additional aspects, the services requested to be activated may also include at least one of device upgrades, device reactivations, wireless number changes, and wireless number porting for wireless devices that have previously been activated. The wireless device 14 to have services activated may include a mobile phone, a smartphone, a wireless computing device or laptop, a tablet, a wireless handheld device, a mobile computing device, or other type of wireless device having services that can be activated wirelessly.

According to some aspects of the disclosure, a vending machine 70 can prompt a user 12 to enter an input selection corresponding to a wireless product/service. The vending machine 70 can automatically retrieve and/or generate wireless device-related information based on a user's input selection. The wireless device-related information can include, for example, the International Mobile Station Equipment Identify (“IMEI”), an Electronic Serial Number (ESN), Mobile Equipment Identifier (MEID), a serial number for a subscriber identity module (SIM) card installed in the wireless device 14 and/or selected service. The SIM card 34 may include a SIM card memory 36 for storing at least a SIM card serial number, for example, an Integrated Circuit Card ID (ICCID). A wireless device not utilizing a SIM card is contemplated as well for use with the invention. The input selection by the user 12 may include a wireless product, service provider, and/or service selection. Automatic retrieval of wireless device-related information can be achieved, for example, by scanning the selected package, device, or service, and/or by pre-programming the related product information when the vending machine 70 is stocked and/or programmed.

The vending machine 70 can generate an activation message that corresponds and/or includes the input selection by the user 12 and the automatically retrieved device-related information. The activation message can be transmitted over a provisioning channel 15 provided over a wireless carrier network 16 that is available to inactive or unprovisioned wireless devices 14, through the vending machine 70. In some aspects, the provisioning channel 15 may include at least one data messaging channel, such as an Unstructured Supplementary Service Data (USSD) channel, a Short Message Service (SMS) messaging channel or a Wireless Application Protocol (WAP) messaging channel, a personal area network (PAN) space at the point-of-sale, such as a Bluetooth™ communication, an induction wireless communication, an infrared wireless communication, an ultra-wideband communication, a ZigBee™ communication, a wireless fidelity communication channel, a local area network (LAN), a communication channel as defined herein, and the such. Using the provisioning channel 15, the activation message can be delivered to a remote site for use in activating services on the wireless device 14.

The provisioning wireless carrier network 16 can receive the activation message via a the provisioning channel 15 and forward the activation message in real time to a subscriber provisioning system 22 operated by a service provider for the activation of one or more services for the wireless device 14. Accordingly, the services requested to be activated can include at least one of: an initial “out of the box” activation of wireless services of an unprovisioned wireless device 14 or device upgrades, device reactivations, wireless number changes, the addition or purchasing of services including airtime, enrollments or content, and wireless number porting for wireless devices 14 that have previously been activated or provisioned. In some aspects, the provisioning wireless carrier network 16 can be connected to a wireless carrier server 18 and forward the activation message to the subscriber provisioning system 22, either directly or through a destination server 20 connected to the subscriber provisioning system 22, to initiate service activation and provisioning of the wireless device 14.

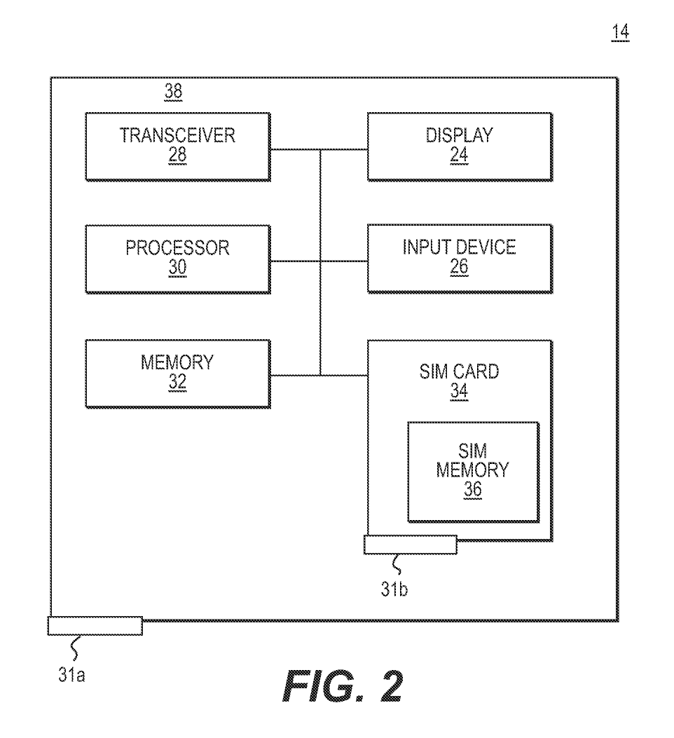

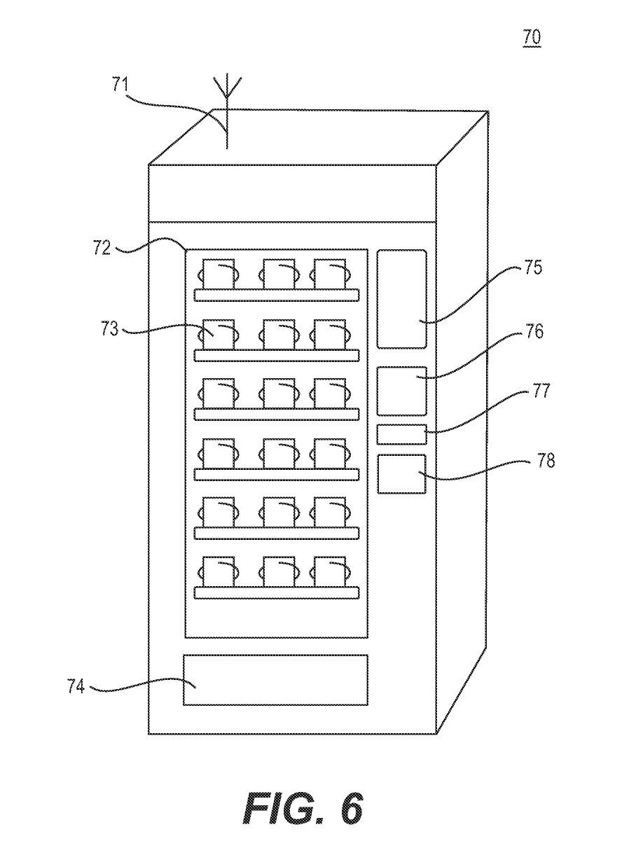

Referring now to FIG. 2, a schematic block diagram of a wireless device 14 in accordance with aspects of the disclosure is depicted. The wireless device 14 may include a display 24, an input device 26, a transceiver 28, a processor 30, a memory 32 and a SIM card 34. In some aspects, one or more RFID tag(s) 31a, 31b may be included, for example, to include information specific to the wireless device 14 and/or the SIM card and allow information retrieval by an RFID reader (not shown). Alternatively, the RFID tag(s) 31a, 31b may be included in the packaging of the wireless device 14 or the like. In some aspects, the display 24 may be used to display a message that can prompt the user 12 to enter a wireless service selection used for activating services on the wireless device 14 and/or to provide a user 12 with directions related to the activation process. The directions may include, for example, to scan the one or more RFID tag(s) 31a and 31b using an RFID reader (shown in FIG. 6) located at the point-of-sale, e.g. the vending machine, or within the wireless device 14. The wireless service selection can be used by the vending machine 70 and entered using the keypad of the vending machine 70 (shown in FIG. 6) when the wireless device is being purchased. If only wireless services are being purchased for an existing inactive wireless device, the display 24 and input device 26 of the wireless device may act as a user interface for the purchase and activation of services.

The memory 32, and/or RFID tags 31a, 31b may be used to store device related information including at least a device serial number, for example, an International Mobile Equipment Identity (IMEI), an Electronic Serial Number (ESN) or Mobile Equipment Identifier (MEID). The SIM card 34 may include a SIM card memory 36 for storing at least a SIM card serial number, for example, an Integrated Circuit Card ID (ICCID). In some aspects, the processor 30 may be coupled to the input device 26, the SIM card 34 and the memory 32 to perform various functions according to aspects of the disclosure.

In some aspects directed to the specific application of prepaid wireless communications, subscriptions can be formulated and the parameters may be loaded onto the SIM card 34 or onto the vending machine 70. For example, the system/service provider may activate subscriptions by loading the subscription's parameters on the SIM card 34 or the vending machine 70 according to the particular wireless device 14 being sold/activated. This allocation may occur before the user 12 actually enables the subscription and activates the subscription on the wireless device 14.

In addition, the SIM card memory 36 and/or vending machine 70 may store a software application for initiating activation of services on the wireless device 14. The software application can be implemented in an external or internal machine-readable medium, which may be any mechanism that provides (i.e. stores and/or transmits) information in a form readable by a processor, such as the processor 30 of the wireless device 14 or forming part of the vending machine 70. For example, the machine-readable medium may be a read only memory (ROM), a random access memory (RAM), a cache, a hard disk drive, a portable storage media, an optical storage media, a flash memory device or any other memory device capable of storing information. The memory may be used to store, arrange and retrieve data. The memory may provide instructions, which when read by a processor, cause the processor to perform operations for initiating activation of services on the wireless device 14.

In some aspects, the software application may automatically be initiated upon the detection of the powering on of the wireless device 14 or a selection input of the user on the vending machine 70, for “out of the box” activation services, wherein the software application may include an initial wireless device boot up sequence that prompts the user 12 to enter an additional selection or payment information to commence activation of a wireless device 14 and/or service. The user selection may be used to determine which particular services and subscriptions are to be provisioned. For example, the user selection may be used to determine the phone number or carrier in order to initiate provisioning. The software application may provide instructions to a processor 30 to collect the selections made by the user 12 along with the wireless device serial number (ESN, IMEI or MEID) and the SIM card serial number (ICCID). The software application may also provide instructions to a processor of the vending machine 70 to generate an activation message, such as a MOPR message, with the collected data and transmit it to the applicable wireless carrier network 16 via a designated provisioning channel 15 that is able to be accessed by inactive wireless devices 14.

In some aspects, the software application may provide instructions to a processor 30 to generate a message to be displayed on the display 24, or a display 75 of the vending machine, in the event that the MOPR is not completed or acknowledged within a predetermined period of time. The message may instruct the user 12 to contact user support in order to activate the wireless device 14. Otherwise provisioning and activation messages may be displayed on one or both displays 24, 75.

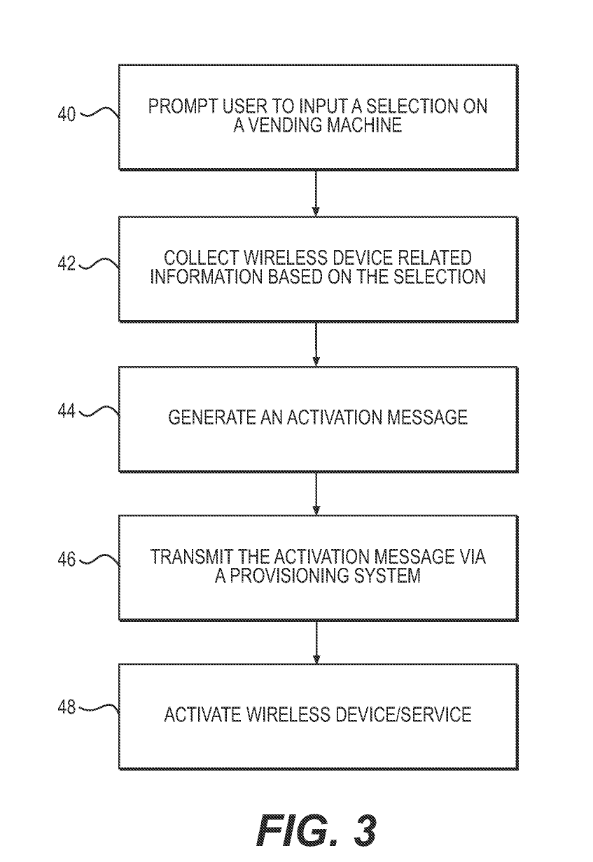

Referring now to FIG. 3, an operation flow diagram illustrating a method of generating an activation message for a wireless device 14 on a vending machine 70 in accordance with aspects of the disclosure is illustrated. Starting at operation 40, upon the detection that activation services are being requested for a wireless device 14 (e.g., upon a user-initiated request input on the vending machine), the vending machine 70 can prompt a user 12 to input a selection. The selection may include choosing a brand, type of wireless device, wireless carrier, and/or service from a particular list of options that can fit the user's needs.

At operation 42, the vending machine 70 can retrieve/collect wireless device related information that corresponds to the selection made by the user. Wireless device related information may include wireless services codes and/or a device serial number, for example, an International Mobile Equipment Identity (IMEI), an Electronic Serial Number (ESN) or Mobile Equipment Identifier (MEID) and/or a SIM card serial number. The information may be retrieved or collected using a processor 30, e.g. of the wireless device 12 and/or of the vending machine, configured to execute instructions of a software program so as to allow the vending machine's processor to automatically retrieve device-related information from a memory.

At operation 44, the vending machine 70 can generate an activation message, which may or may not be encrypted, including the user's selection(s) and the retrieved device-related information in operation 42. The vending machine 70 may then transmit the activation message over the provisioning channel 15 accessible by the vending machine 70 and/or inactive wireless devices, at operation 46. The activation message delivered by the vending machine 70 can be used for the activation of services on the inactive wireless device 14 selected by the user 12. In some aspects, such as when establishing a USSD connection, the vending machine 70 may establish an activation session over the provisioning channel 15 to transmit the activation message to a wireless carrier.

The provisioning channel 15 may include a USSD, SMS, WAP, PAN, the communication channel as defined herein, or other suitable communication to support the transmission and delivery of the MOPR from inactive wireless device 14. This provisioning channel 15 is different from the normal communications channel over which the wireless device 14 may conduct normal communications over the wireless carrier network 16 once activated and/or provisioned. The provisioning channel 15 created via the vending machine 70 may be available to inactive/unactivated wireless devices 14 having the special-purpose SIM card software application that instructs the wireless device 14 to activate itself over the provisioning channel 15. Accordingly, at operation 48, the wireless device/service may be activated.

Other types of system hardware and software than those described here could also be used. The types may depend on the capacity of the wireless carrier network 16 and/or the ability to accommodate multiple requests for service activation. For example, the wireless carrier server 18 may be part of a server farm or server network, which is a logical group of one or more servers. As another example, there could be multiple servers 18 that may be associated or connected with each other, or multiple servers could operate independently, but with shared data. In a further aspect and as is typical in large-scale systems, application software could be implemented in components, with different components running on different server computers, on the same server, or some combination. One skilled in the art will recognize that although referred to in the singular, a processor or server may actually include a plurality of computing devices that operate together to provide data in response to requests from other computing devices. Thus, as used herein the term processor or server more accurately refer to a computing device or set of computing devices that work together to respond to specific requests.

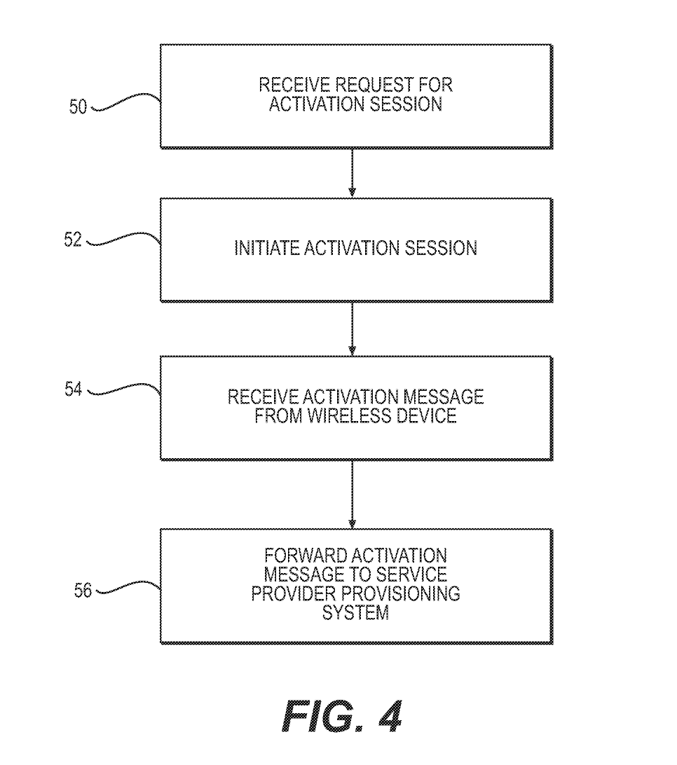

Referring now to FIG. 4, an operation flow diagram illustrating a method of forwarding an activation message over a wireless carrier network 16 in accordance with some aspects of the disclosure is illustrated. The wireless carrier network 16 can receive a request over the provisioning channel 15 from the vending machine 70 to initiate an activation session (e.g., a USSD connection session) in operation 50. The wireless carrier network 16 can then establish an activation session with the wireless device 14 in operation 52. In operation 54, the wireless carrier network 16 can receive the activation message transmitted over the provisioning channel 15 accessible by the vending machine 70. In some aspects, in which an activation session may not be required, the wireless carrier network 16 does not have to perform the operations associated with establishing an activation session and can simply receive the activation message transmitted from the vending machine 70. Once the activation message is received, the wireless carrier network 16 may forward the activation message to the subscriber provisioning system 22 which can be operated by a service provider in operation 56 for the activation of services.

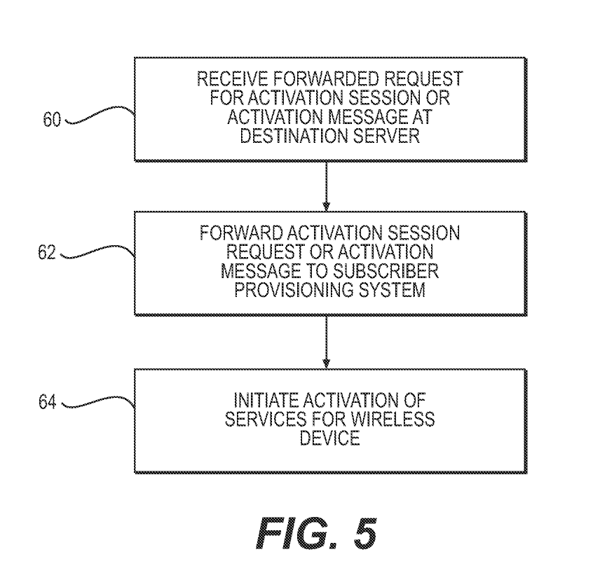

Referring now to FIG. 5, an operation flow diagram is provided illustrating a method of operating a subscriber provisioning system 22 to activate services on the wireless device 14 in accordance with some aspects of the disclosure. The subscriber provisioning system 22 may have a server or a plurality of servers that operate independently or together in response to one or more requests for service activation on wireless devices 14. At the service provider site, a destination server 20 may also be connected to the subscriber provisioning system 22 for receiving incoming activation messages and forwarding them to the subscriber provisioning system 22 for service activation and provisioning of the wireless device 14. The destination server can receive an activation message or a request to establish an activation session from the wireless carrier network 16 in operation 60. The destination server 20 may forward the request or activation message to the subscriber provisioning system 22 in operation 62. The request or activation message can be processed in operation 64 to initiate the activation of services on the wireless device 14.

The subscriber provisioning system 22 may be configured to receive the activation message from the wireless carrier network 16 and may further include a network interface module (not shown) for maintaining connectivity with the wireless carrier network 16 in order to receive activation messages therefrom. For example, the subscriber provisioning system 22 may receive the activation message via USSD, a Short Message Service (SMS), a Virtual Private Network (VPN), a Digital Signal 3 (DS3), Signaling System #7 (SS7), a personal area network (PAN), a communication channel as defined herein, other suitable connectivity, or communication channel. In some aspects, once the subscriber provisioning system 22 receives the activation message, the provisioning channel for that subscription can remain active or be deactivated. Further, the activation message may then be processed by existing back office processes. Error handling and messaging may be used to identify, record, and respond to erroneous or missing data from the activation message.

The activation messaging may be used to provide additional subscriber services and additional features for the SIM software application to support the additional services. This may enhance the use of the MOPR activation message for subscriber self-services by utilizing existing network and infrastructure for subscriber provisioning systems 22 and wireless carrier networks 16. For example, the activation messaging of the disclosure may enable a user 12 to initiate service requests directly from the vending machine 70 at the point of sale to perform a number of possible subscriber self-services, such as but not limited to activation, upgrade, reactivation, perform a wireless number change, and/or request a wireless number port provisioning request, allowing such service requests through their handset without requiring access to an agent, website or another telephone.

Referring now to FIG. 6, an exemplary vending machine 70 configured to activate services on a wireless device 14 in accordance with aspects of the disclosure is depicted. In particular, the vending machine 70 may access a provisioning channel 15 used to activate services on a wireless device 14. Moreover, the vending machine 70 may automatically retrieve wireless device related information and generate an activation message that can be sent through the provisioning channel 15 for the activation of the wireless services as described herein. In some aspects, the vending machine 70 can include a communication device 71 configured to provide a wireless local area network, personal area network and/or other communication channel to activate services on a previously purchased inactive wireless device 14.

The exemplary vending machine 70 can be configured to form a communication between an inactive wireless device 14 and a provisioning channel 15, to activate services on the wireless device as described herein. Services requested to be activated can include for example, device initial activation, device upgrades, device reactivations, wireless number changes, wireless number porting, and the addition or purchasing of services including airtime, enrollment, content, or the like. The communication device 71 can form a local area network, utilizing wireless fidelity communication, a personal area network communication, such as Bluetooth™, and/or other communication channel as defined herein with an inactive wireless device. The communication may be used to transmit information between a subscriber provisioning system 22 (shown in FIG. 1) and the wireless device 14 and facilitate the activation and selection of services by the user 12 and/or seller. Alternatively, in some aspects the communication device 71 may not be implemented as part of the wireless device provisioning system 100.

A product display 72 can form part of the vending machine 70 at the point-of-sale. The product display 72 may simply be, for example, a window showing the items for sale, a digital screen configured to play advertisements relating to the wireless devices and/or services, a cover with pictures of the products contained inside the machine, and the like. The items for sale 73 can include a variety of wireless devices including mobile phones, smartphones, tablet computers, gaming systems, MP3 players and the like, as well activation services. Activation services can include, for example, a card with airtime or credits that can be used by a wireless device. The card with airtime or credits can be dispensed by the vending machine 70 with the wireless device or sold separately.

A product dispensing system 74 can be included in the vending machine 70. The product dispensing system 74 can dispense a product that has been purchased by a customer. When the purchased product is a service, however, the product dispensing system 74 may not be required. For example, a code may be displayed, using an information display 75, transferred, using the communication device 71, transmitted as part of the activation message, sent directly to the inactive wireless device, or printed on a receipt, to allow the activation of the purchased service on a previously purchased wireless device 14. The information display 75 may additionally display information about the products available, information and/or instructions to complete the selection, activation of a service, and payment of an item 73. A keypad 76 may also be included for a user 12 to input a selection regarding selection, payment, and/or activation of an item 73. In some aspects, a touch screen display 75 may be included to eliminate the need for a separate keypad 76.

A payment mechanism 78 can also be included in the vending machine to receive payment for a purchased product 73. The payment mechanism may function with the information display 75 and include a credit card reader, credit card machine, cash machine, and the like. In some aspects, a scanner 77 such as a RFID scanner or barcode scanner may also be included in the vending machine 70 at the point-of-sale. The scanner 77 may be used to quickly transfer information regarding the purchased product and/or an inactive previously purchased product, and facilitate the activation and/or purchasing process. This may allow the vending machine 70 to automatically generate an activation message at the point-of-sale to be sent to the subscriber provisioning system 22 as described in related sections of this disclosure.

The vending machine 70 may include a number of additional features. In particular, the vending machine 70 may include a robust housing to hold items 73 in a secure manner. The housing may be constructed to protect the internal components from the environment and to limit damage. The housing may further include an access door for the purchaser to retrieve dispensed items 73. The housing may further include configurations to receive power and/or communication. Additionally, the housing may be configured to provide lighting for the items 73.

The vending machine 70 may include one or more processors to implement the activation steps, the payment mechanism 78, and product dispensing system 74. The one or more processors may include random access memory, read-only memory, input devices (including the scanner 77, the keypad 76, the barcode reader, the RFID scanner, the touchscreen display 75, and/or the like), output devices (including the display 75, the communication device 71, a printer, and/or the like), communication components including transceivers, universal asynchronous receiver transmit devices, and the like. According to aspects of the disclosure, the one or more processors may be configured to collect automatically retrieve wireless device related information and generate the activation message. The activation message can include, for example, the user's selection, the SIM card serial number, and the device serial number. Moreover, the activation message can be a request for the provisioning or activation of services originating from the vending machine 70, otherwise referred to herein as a Mobile Originating Provisioning Request (MOPR) message. In some aspects, the activation message may be encrypted to ensure messages are secure, intact and not corrupted. The activation message may then be transmitted to a remote site via a provisioning channel 15 available to inactive wireless devices and/or the vending machine 70 for requesting activation of services on the wireless device. The provisioning channel 15 may be, for example, an Unstructured Supplementary Service Data (USSD) channel, a Short Message Service (SMS) messaging channel or a Wireless Application Protocol (WAP) messaging channel, a communication channel as defined herein, or other suitable connectivity.

In some aspects in which a USSD channel is made available for an inactive wireless device 14 to utilize, the wireless device 14 can request a USSD session in which a real time connection session is established between the wireless device 14 and a remote device over the USSD provisioning channel 15. For example, USSD can be a session oriented service that allows the real time exchange of information during a communication session, as opposed to other types of messaging data channels that require the storage and forwarding of messages. During the USSD real time connection session, the activation message may be transmitted from the wireless device 14 to the remote component with which it has established a USSD connection session. A typical USSD message may start, for example, with a “*” followed by digits which indicate an action to be performed or are parameters, with each group of numbers separated by a *, and the message is terminated with a “#.” Thus, by way of example without limitation, the activation message may appears as follows over the USSD connection “*[service provider forwarding code]*[activation code]*[SIM card serial number]*[device serial number]#.”

The product dispensing system 74 may be operated by the one or more processors. The product dispensing system 74 may include mechanical components to hold items 73 and release items 73 upon actuation by the processors. The mechanical components may include various actuators and associated structure to hold and dispense items 73. The payment mechanism 78 may communicate or be part of the one or more processors. Together, the various input and output devices may operate with the payment mechanism 78 to effectuate a sale. Thereafter, the one or more processors may operate with the product dispensing system 74 to dispense an item 73 to the purchaser after sale has been completed.

In a particular implementation, the vending machine 70 may hold a wireless device as one of the items 73, airtime cards as a another one of the items 73, a wireless device bundled with an airtime card as one of the items 73, and the like. In some aspects, the vending machine 70 may be used to sell/dispense other products as well.

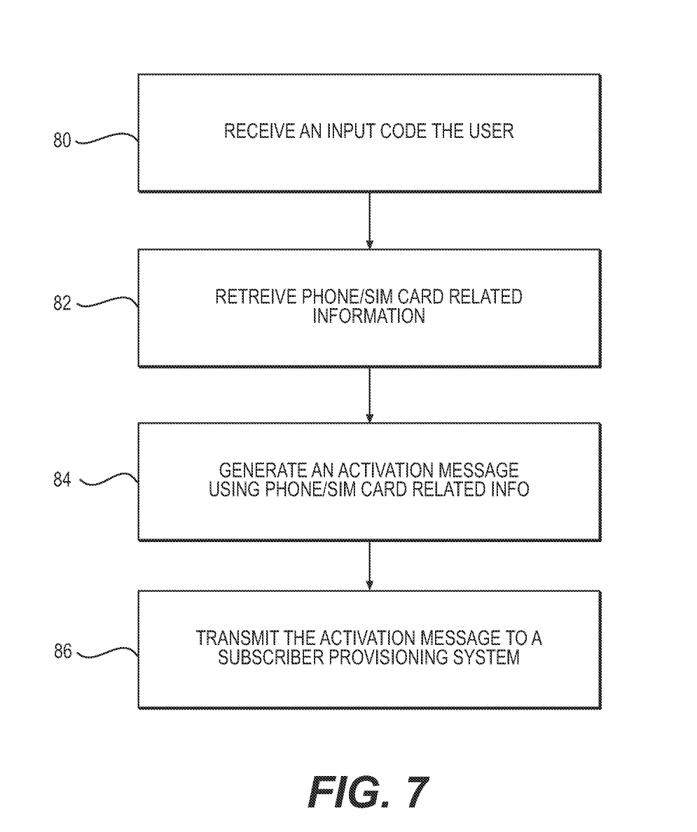

Referring now to FIG. 7, a flow diagram illustrating method steps associated with the activation of a wireless device according to aspects of the disclosure is illustrated. In particular, the activation implementing a local area network/personal area network communication with the wireless device 14 to facilitate the activation the wireless device 14 and/or service. An initial input from a user 12 and/or seller of a wireless device 14 can be received by a user interface in operation 80. The initial input may be, for example, a wireless device 14 or service selection. The selection may trigger an instruction or grant of permission for a wireless device 14 communicate over a wireless device provisioning system 100 as described above. As further described in the examples below, the input may additionally, or alternatively, include a code relating to a request for the activation of a service of the wireless device.

As previously explained, the wireless device 14 and SIM card 34 may include related information that can include at least a serial number, for example, an International Mobile Equipment Identity (IMEI), an Electronic Serial Number (ESN) or Mobile Equipment Identifier (MEID), and a SIM card serial number which can be retrieved in operation 82. The retrieval may include the use of the scanner 77 at the vending machine 70. Automatic retrieval may also occur according to a preprogrammed protocol in the wireless device 14 and/or vending machine 70. The retrieved information can be used to generate an activation message at operation 84. The activation message can be transmitted to a subscriber provisioning system 22 through the provisioning channel 15 in operation 86.

The following examples provided below demonstrate without limitation exemplary functionality using activation messaging on various provisioning channels.

### Example 1

### USSD MOPR and Messaging Solution

According to one or more aspects, the vending machine 70 and/or SIM software application may be programmed to prompt a user 12 of the wireless device 14 with one or more of the following options at the point-of-sale during the purchase and activation of a wireless service:

Option 1: Activation. If option 1 is selected for activation of the wireless device 14, the vending machine software application may prompt the user 12 to enter the selection of a wireless service to be included in the activation message. Optionally, the user 12 may further be prompted to provide a 10 digit user contact number in case the user 12 needs to be reached if there are any problems activating the wireless device. In some aspects, the activation message may include one or more of the following information used for activation purposes: Short Code (from SIM software application), a Reseller ID (from SIM software application), Transaction ID “1” (from SIM software application), IMEI (from handset), ICCID (from SIM software application), activation code (e.g., zip code) retrieved automatically according to the location of the vending machine 70 or input by a user, and a 10 digit optional user contact number (user input value).

Option 2: Number Change. If option 2 is selected for a number change, the vending machine 70 and/or SIM software application may prompt the user 12 to enter an activation code, provided after payment has been received by the vending machine 70, to be included in the activation message. The vending machine may further prompt a message to the user 12 advising that they will lose their existing wireless number and that a new number will be assigned. In one or more aspects, the activation message may include one or more pieces of the following information used for upgrade purposes: Short Code (from SIM software application), Reseller ID (from SIM software application), Transaction ID “4” (from SIM software application), IMEI (from handset), ICCID (from SIM software application), and activation code (user input value).

Menu Option 3: Port. If option 3 is selected for porting, the display on the vending machine may display, “Call Customer Service to submit your port request.”

Menu Option 4: Add Services. If option 4 is selected for Purchasing, Adding Airtime Service or Enrollments, the vending machine may prompt the user 12 to enter information, such as an airtime pin number and/or an alphanumeric promotion code credit card number or account information, to be included in the activation message and used for the purposes of the subscriber provisioning system 22. In one or more aspects, the activation message may include one or more pieces of the following information: Short Code (from SIM software application), Reseller ID (from SIM software application), Transaction ID “3” (from SIM software application), IMEI (from handset), ICCID (from SIM software application), Airtime Pin (user input value), and an optional promotion Code (user input value) or any other required information.

In one or more aspects, the vending machine 70 software application may automatically retrieve and/or validate field length on all user input values to ensure the correct or a sufficient number of characters are entered by the user 12. For example, the character length validation input value may be as follows: zip code=5 digit validation according to the location of the vending machine, user contact number=null or 10 digit validation, mobile number=10 digit validation, old IMEI or last 5 digits of old IMEI=greater than 5 digit validation, airtime pin=greater than 14 digit validation, promotion code=null or 5 digit validation, and old ICCID=7 digits. If the required length of characters is not entered by the user 12, the vending machine's 70 information display 75 may display the following message: “Invalid entry. Please try again.” In one aspect, after 3 attempts by the user 12 to enter the correct number of characters on any application option, the information display 75 may display “Call Customer Service” on the handset display.

Once the user 12 completes the required input based upon the selected menu option, the vending machine 70 may establish a USSD connection via a provisioned USSD short activation code. Once the USSD connection is established, the SIM software application may generate the MOPR and deliver the message via the wireless device 14 to the destination server 20 based upon the selected menu option.

In one aspect, the vending machine 70 software application may perform error handling and message acknowledgement. For example, for Off Network Validation, after three (3) unsuccessful attempts by a user 12 through any application option, the SIM software application may present “Call Customer Service on the handset display. For Network Down Validation, if the wireless carrier network 16 is unable to connect with or deliver the MOPR to the destination server 20, the wireless carrier network 16 may return an acknowledgment to the wireless device 14 as a text string “Call Customer Service” which will show on the handset display 24.

While various aspects described herein have described the provisioning channel 15 as being a USSD channel available for use by inactive wireless devices 14, it is further understood that other types of messaging channels available for use by the vending machine and/or inactive wireless devices 14. By way of example but without limitation, such other types of messaging channels may include SMS, WAP, or the like.

One skilled in the art would appreciate that the examples described above, are merely illustrative of exemplary software application functionality using activation messaging on different provisioning channels. It is understood by a person skilled in the art, the additional functionalities may be implemented along with the different functionality of the vending machine disclosed. For example, the software application may be able to be flexed (enabled) “on” or “off” at the point of manufacturing. Further, the user entry or input fields may be table driven to support additional entries as required by changing needs in the future and may be able to be added or modified via administrative over-the-air (OTA) messaging, and the available menu options for the activation of services can be flexed (enabled) “on” or “off” and updated via administrative over-the-air (OTA) messaging (e.g., USSD or SMS). In some aspects, a user 12 may not be charged service charges for the USSD, SMS or WAP activation and browsing messages. In some aspects, the particular wireless carrier network 16 and type of provisioning channel can vary and be changed or modified. In one aspect, the vending machine may be configured to support Re-Boot and Rescan radio functionality on the wireless device 14 being activated. The vending machine software application may also delete the LOCI file upon generating and sending the MOPR. These features may be customizable at the point of manufacturing by the carrier as the requirements may vary based upon HLR configuration or the provisioning channel selected for the activation message. Finally, additional Subscriber Services Menus may be added to support any service requests that would be required in the future.

As can be envisioned by a person skilled in the art, the systems and methods described may be used to activate various services on a wireless device 14 through use of a provisioning channel 15 accessible by the vending machine 70 and/or inactive or unprovisioned wireless devices 14. In one or more aspects, the simplified activation system and method described in various aspects herein improve the user's 12 experience by providing a new messaging channel for service activations and limiting a user's need to use the Internet or telephone for access to the service provider's back office system for the purpose of wireless service activations. It further reduces the chance for user input errors and simplifies the activation process. This reduction of required user input improves wireless service activation success rates of initial activations and expands the accessibility of wireless service to users that do not have access to traditional wired communication services or access to another telephone for activation. The invention also leverages existing service provider's back office systems and the wireless carrier's current network and infrastructure.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

In an aspect, the invention may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various aspects of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

While the apparatus and method have been described in terms of what are presently considered to be the most practical and preferred aspects, it is to be understood that the disclosure need not be limited to the disclosed aspects. It is intended to cover various modifications and similar arrangements included within the spirit and scope of the claims, the scope of which may be accorded the broadest interpretation so as to encompass all such modifications and similar structures. The disclosure includes any and all aspects of the following claims.

1. A method for activating services on a wireless device, the method comprising:
providing a vending machine configured to receive at least one user input selection to be used for activating services on a wireless device;
the providing further comprising providing the vending machine configured to automatically retrieve device-related information, wherein the device-related information includes at least a serial number for the wireless device;
the providing further comprising providing the vending machine configured to generate an activation message including one or both of the at least one user input selection and the device-related information; and
the providing further comprising providing the vending machine configured to transmit, using a provisioning channel, the activation message to a subscriber provisioning system.

2. The method of claim 1, wherein the automatically retrieved device related information additionally includes a serial number for a subscriber identity module (SIM) card configured to be installed in the wireless device.

3. The method of claim 2, wherein the automatically retrieved device related information is retrieved by scanning a code identifier.

4. The method of claim 2, wherein the device-related information is automatically retrieved from a pre-programmed database including information corresponding to the at least one of the wireless device and a wireless service.

5. The method of claim 1, wherein the step of providing additionally comprises providing the vending machine configured to receive payment using an automated payment mechanism for the purchase of a wireless service.

6. The method of claim 1, wherein the step of providing additionally comprises providing the vending machine configured to receive payment using an automated payment mechanism for the purchase of a wireless device.

7. The method of claim 1, wherein the step of providing additionally comprises providing the vending machine configured to display wireless service information on a display of the vending machine.

8. The method of claim 7, wherein the step of providing additionally comprises providing the vending machine configured to receive a wireless service or a wireless device selection from a user through a user interface of the vending machine.

9. The method of claim 1, wherein the received user input selection used to activate services on the wireless device is received by the vending machine using a personal area network (PAN) accessible by inactive wireless devices at the vending machine.

10. A method of activating wireless services on a wireless device, the method comprising:
receiving a user input selection through a user interface of a vending machine providing wireless services and wireless devices, wherein the user input selection relates to at least one of a wireless service and a wireless device selection;
retrieving, using the vending machine, device-related information according to the user input selection, wherein the device-related information includes at least a serial number for the wireless device;
generating, using the vending machine, an activation message including the device-related information; and
transmitting, using a provisioning channel, the activation message to a subscriber provisioning system configured to activate services on wireless devices.

11. The method of claim 10, additionally comprising: retrieving a serial number for a subscriber identity module (SIM) card configured to be installed in the wireless device.

12. The method of claim 10, additionally comprising: receiving payment using an automated payment mechanism of the vending machine.

13. The method of claim 10, additionally comprising: displaying wireless service information on a display of the vending.

14. The method of claim 10, additionally comprising: communicating by the vending machine with an inactive wireless device, through a personal area network (PAN) in communication with the vending machine.

15. The method of claim 14, additionally comprising: activating a wireless service via the personal area network formed between the inactive wireless device and the vending machine.

16. A system configured to provide wireless services, the system comprising a vending machine, the vending machine comprising:
a keypad configured to receive at least one user input selection used for activating one or more services on a wireless device;
a processor in communication with the keypad and a transceiver, wherein the processor is configured to:
automatically retrieve device-related information including at least one of a serial number for the wireless device and a serial number for a subscriber identity module (SIM) card installed in the wireless device upon receiving the at least one user input selection,
generate an activation message including the automatically retrieved device-related information, and
transmit, using the transceiver and a provisioning channel, the activation message to a subscriber provisioning system configured to activate services on the wireless device.

17. The system of claim 16, wherein the processor is additionally configured to process a payment for the one or more services.

18. The system of claim 16, wherein the vending machine comprises a communication device configured for an inactive wireless device to access a personal area network (PAN) for the activation of one or more service(s) on the inactive wireless device.

19. The system of claim 16, wherein the vending machine is additionally configured to display wireless service information on a display of the vending machine.

20. The system of claim 16, wherein the vending machine comprises a programmable database configured to store serial numbers for subscriber identity module (SIM) cards and wireless devices' international mobile station equipment identity (IMEI) numbers.
